(19) United States
(12) Patent Application Publication
(10) Pub. No.: US 2008/0020151 A1
(43) Pub. Date: Jan. 24, 2008

(54) Adhesive Print Medium For Use With An Ink Jet Imaging Apparatus

(76) Inventor: Jun Li, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/458,827

(22) Filed: Jul. 20, 2006

(51) Int. Cl. B41M 5/50

(52) U.S. Cl. 428/32.34

(57) ABSTRACT

An adhesive print medium for use with an ink jet imaging apparatus includes a first layer having a first side and a second side, and a compound applied to the second side of the first layer, the compound being formulated as both an adhesive and an ink receiving substrate to receive and retain ink ejected from the ink jet imaging apparatus, the compound forming a second layer. The ink ejected from the ink jet imaging apparatus is viewed from the first side of the first layer.

### FIELD OF THE INVENTION

The present invention relates to imaging, and, more particularly, to an adhesive print medium for use with an ink jet imaging apparatus.

### BACKGROUND OF THE INVENTION

Ink jet printers are employed by both home and commercial users for various purposes, including the creation of images on an adhesive print medium that the user desires to adhere to various articles. For example, a suer may create an image consisting of textual or graphical information that the user desires to affix to household articles, such as food containers, or to personal articles, such as coffee cups, cellular phones, and the like. Commercial users may create images used for advertising, such as wherein an image may be included as part of an advertising display, which may or may not be backlit. Another example may be instructions for the use of a particular piece of home or business equipment that are desired to be adhered to the particular piece of equipment so as to aid a user in operating that equipment. In each such case, an adhesive print medium is employed that incorporates an ink-receiving sheet capable of receiving ink from a convention ink jet printer, i.e., a print medium that retains the ink that is ejected from typical ink jet printers.

However current adhesive print media that are capable of adhering to objects may be costly to manufacture, and hence, expensive to purchase. Also, such print media may often be cumbersome to use, and may experience problems in use, such as smearing of the ink, scratching of the surface that receives the ink, and contamination of the ink by water or other materials that may come into contact with the surface upon which the ink has been deposited.

What is needed in the art is an improved adhesive print medium for use with an ink jet imaging apparatus.

### SUMMARY OF THE INVENTION

The present invention provides an adhesive print medium for use with an ink jet imaging apparatus and a corresponding method of printing on the adhesive print medium.

The present invention, in one form thereof, relates to an adhesive print medium for use with an ink jet imaging apparatus. The print medium includes a first layer having a first side and a second side, and a compound applied to the second side of the first layer, the compound being formulated as both an adhesive and an ink receiving substrate to receive and retain ink ejected from the ink jet imaging apparatus, the compound forming a second layer. The ink ejected from the ink jet imaging apparatus is viewed from the first side of the first layer.

The invention, in another form thereof, relates to a method of printing an image on an adhesive print medium. The method includes providing the adhesive print medium for use with an ink jet imaging apparatus. The adhesive print medium includes a first layer having a first side and a second side, and a compound applied to the second side of the first layer, the compound being formulated as both an adhesive and an ink receiving substrate to receive and retain ink ejected from the ink jet imaging apparatus, the compound forming a second layer. The method further includes ejecting the ink from the imaging apparatus onto the second layer to print a patent image based on a latent image, wherein the patent image is viewed from the first side of the first layer.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 depicts an adhesive print medium in accordance with an embodiment of the present invention.

FIG. 2 depicts a cross section of the adhesive print medium of FIG. 1 having two layers.

FIG. 3 depicts a cross section of the adhesive print medium of FIGS. 1 and 2, further including a third layer.

FIG. 4 depicts a supply of print media in accordance with an embodiment of the present invention.

FIG. 5 depicts a supply of print media configured in the form of a roll, in accordance with an embodiment of the present invention.

FIG. 6 is a flowchart depicting a method of printing an image on an adhesive print medium in accordance with an embodiment of the present invention.

FIG. 7 depicts an adhesive print medium in accordance with an embodiment of the present invention being printed upon by an ink jet imaging apparatus.

FIG. 8 depicts an adhesive print medium in accordance with the embodiment of FIG. 7 having been applied to an article after being printed.

Corresponding reference characters indicate corresponding parts throughout the several views. The exemplifications set out herein illustrate embodiments of the invention, and such exemplifications are not to be construed as limited the scope of the invention in any manner.

### DESCRIPTION OF THE PREFERRED EMBODIMENT

A transparent sheet/label is desirable type of an adhesive ink-receiving sheet, because it may be applied to various articles, for example glassware, windows, stationary, cellular phones, advertising displays, office equipment, etc., for example, to label or identify the article, to provide instructions regarding the use of the article, or simply to serve as an advertisement.

Such an adhesive print medium may include a transparent printing sheet having a printed side on which information is printed by a printer, an adhesive layer stacked on the other side of the printed side of the printing sheet, and a separable protective sheet stacked so as to cover the adhesive layer. In use, the protective sheet is removed, and the printed sheet is applied to an article.

However, drawbacks of such print media include that the printing side of the sheet usually needs an ink-receiving coating/layer, so as to be able to receive the ink that is printed, which makes the sheet a four-layer structure that may be relatively costly. In addition, the printed surface holding the ink is vulnerable to water or other materials, scratching, staining, smearing, corrosion, oxidation, etc, which may adversely affect the printed information. A transparent protective film may be used to cover the surface after the printing is completed. However, it may be difficult and time consuming for the user to position the protective film to the surface. In addition, the addition of the protective film further increases the cost of the print medium.

An adhesive label scheme may employ a protective film over an adhesive, wherein the protective film is printed upon in a middle area of the label. The film has a cut extending around its periphery, and the peripheral area of the film is removed to expose adhesive. However, with this approach, only the periphery of the label is adhered to the desired article, with the result being that the adhesion force provided by the peripheral region may not be strong enough to keep the print media adhered to the article in many situations. In addition, it increases the cost of the label to manufacture the cut into the protective film so as to make the peripheral area separately removable. Further, it may be difficult for a user to remove only the peripheral portion of the protective film without accidentally removing the printed portion, which would yield a label having no adhesive.

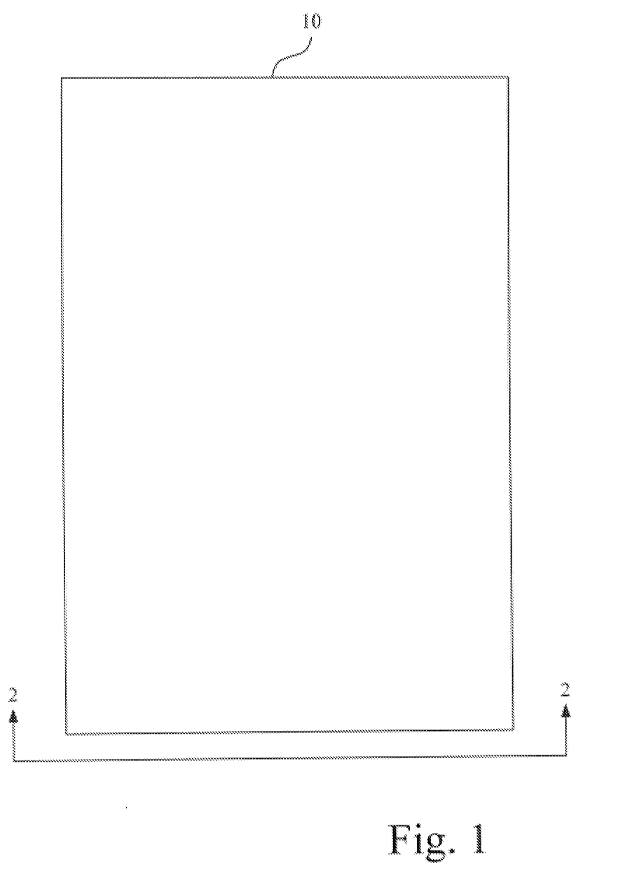

Referring now to the drawings and particularly to FIG. 1, there is shown an adhesive print medium 10 for use with an ink jet imaging apparatus in accordance with an embodiment of the present invention that does not have the disadvantages set forth above. Print medium 10 is for use in printing with an ink jet imaging apparatus, such as an ink jet printer, copier, or fax machine, that produces a printed output of a latent image by ejecting ink onto the print medium, and may be in the form of, for example, single precut sheets or rolls of various sizes, or precut labels.

As used herein, an image is a rendering such as may be obtained via a digital camera or scanner, or which may be created or manipulated on a computer, such as a conventional personal computer or a workstation, and which may be printed or displayed for viewing by the human eye. In printed form, an image is referred to as a patent image. Images may be created or manipulated, for example, using conventional work processing software, graphics software, photography software, and the like. In order to print a latent image, i.e., to render a patent image from a latent image, an ink jet imaging apparatus ejects ink onto the print medium. As used herein, ink is a colorant used by a typical ink jet imaging apparatus to create a patent image, and may be, for example, a dye-based ink, a pigment-based ink, or any colorant that is ejected by an ink jet imaging apparatus onto a print medium to form the patent image.

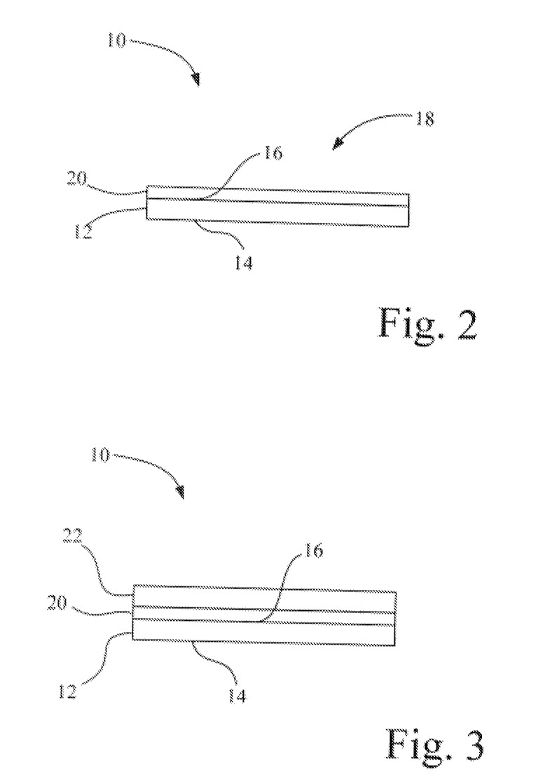

Referring now to FIG. 2, a cross section of adhesive print medium 10 is depicted. Adhesive print medium 10 includes a first layer 12 having a first side 14 and a second side 16. Print medium 10 also includes a compound 18 applied to second side 16 of first layer 12. Compound 18 is formulated as both an adhesive and an ink receiving substrate to receive and retain ink ejected from the ink jet imaging apparatus. Compound 18 forms a second layer 20 of print medium 10. By being formulated as an adhesive, compound 18 allows print medium 10 to adhere to various objects. In addition, by being formulated as an ink receiving substrate, compound 18 allows print medium 10 to receive and retain ink ejected from an ink jetting apparatus. Although it may be possible to eject ink onto most any surface, it will be understood that an ink receiving substrate in accordance with the present invention is specifically designed to receive and retain the ink ejected from the ink jetting apparatus, and hence, is generally less susceptible to artifacts, such as smearing and bleeding, than surfaces not specifically designed to receive and retain ink.

In addition, when printed, the ink ejected from the ink jet imaging apparatus is viewed from first side 14 of the first layer, whereas the second layer that receives the ink faces the article to which print medium 10 is adhered, first layer 12 acting as a protective layer that helps protect the ink and the printed surface from water or other materials, and from scratching, staining, smudging, smearing, and oxidation. Hence, with the present invention, a separate protective sheet is not required, which may thus avoid additional cost and increase the case of use, while providing a strong and uniform bond strength.

In the present embodiment, first layer 12 is a transparent sheet. However, it is alternatively considered that first layer 12 may be translucent or opaque, for example, such as where print medium 10 will be viewed using backlighting. First layer 12 may be made from various materials, which include rigid materials such as glass, and flexible materials such as PE, PP, PVC, PU, PET, as well as other similar such materials known to those skilled in the art.

Similarly, in the present embodiment, second layer 20 is transparent. However, it is alternatively considered that second layer 20 may be translucent or opaque, for example, such as where print medium 10 will be viewed using backlighting.

In the present embodiment, compound 18 used to form second layer 20 is a pressure sensitive adhesive (PSA), such as is used in adhesive tape and labels, although it will be understood that other adhesives may be employed without departing from the scope of the present invention. PSA's generally combine a high degree of tackiness, for instantaneous bonding, with a high cohesive strength to facilitate removal of the PSA from the article to which the print medium is attached, while reducing the amount of any residue remaining on the surface of the article. Acrylic copolymers are common PSA materials today. PSA materials also include elastomers, polyvinyl ethers, silicones, polyurethanes, polyesters, and the polymers known to those skilled in the art.

In order to function as an ink receiving substrate, compound 18 is formulated with ink receiving materials. In the present embodiment, the ink receiving materials absorb ink ejected from an ink jet imaging apparatus. It is alternatively contemplated that the ink receiving materials may be porous. Examples of ink absorbing materials include any single or combination of polymeric materials utilized in polymer-based photo paper, which include, for example, gelatin, polyvinyl alcohol, acrylate polymer, polyethylene glycol, and other similar materials known to those skilled in the art, such as would absorb ink and swell in accordance with the amount of ink absorbed.

Examples of porous particles as ink-receiving materials include particles made of silca, alumina, and polymers. The porous ink-receiving particles may be used as filler in compound 18.

An appropriate concentration of ink-receiving materials in the PSA is characterized by second layer 20 having a good ink-receiving capacity as would be sufficient to retain an amount of ink used in typical ink jet printing, while maintaining a binding force appropriate for the application, e.g., enough binding force to hold print medium 10 to the desired article. For example, in some applications, it may be desirable for the print medium to be permanently adhered to the desired article, in which case a stronger binding force is required in comparison to a semi-permanent application wherein it is desired to easily remove the print medium from the article by peeling it off with a small amount of effort from a human hand.

The pressure sensitive adhesive materials and ink-receiving materials are blended in a ratio such that the dry films of the blend have both bind strength comparable to that of a common PSA tape and ink absorbing ability comparable to that of polymer-based photo paper upon printing. Depending on the material properties, the blend can be prepared as homogeneous solution or emulsion/dispersion in the proper solvent. This solution/emulsion/dispersion can be applied to the transparent layer by cast coating, blade coating, spin coating or any other coating methods known to those skilled in the art, for example, in the paper or adhesive industry.

Referring now to FIG. 3, the present embodiment print medium also includes a third layer 22 positioned adjacent second layer 20 opposite first layer 12. Third layer 22 is in protective contact with second layer 20 in order to protect second layer 20 from contamination until print medium 10 is ready to be used. Third layer 22 is separable from second layer 20, i.e., it may be readily removed from second layer 20 by peeling it from second layer 20 in order to expose second layer 20 for printing. Second layer 20, on the other hand, is inseparable from second side 16 of first layer 12, i.e., not easily removed from second side 16. Third layer 22 may be any material commonly used in the art to protect an adhesive and be easily removable from the adhesive, such as those materials used as a peelable backing on stick-on labels, adhesive tape, and the like.

Other embodiments of print medium 10 may not include third layer 22, which may further reduce the cost of print medium 10, and hence, increase the efficiency of print medium 10 to users. In such embodiments, first layer 12 serves protect second layer 20 from contamination until print medium 10 is ready to be used.

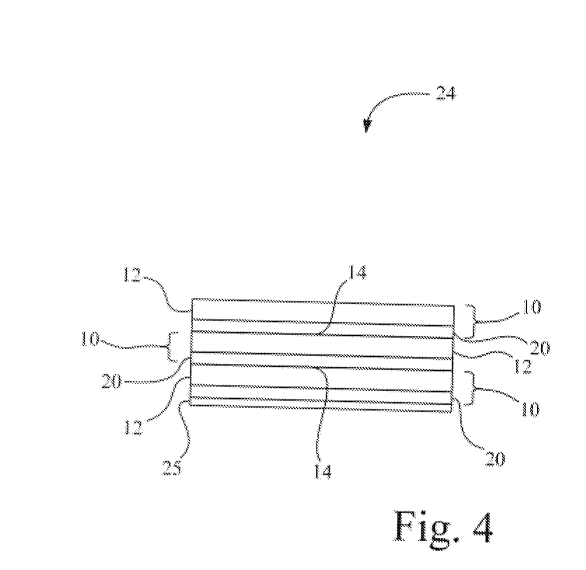

For example, referring now to FIG. 4, in another embodiment, a supply of print medium 10 is in the form of a stack 24 of individual sheets of print medium 10. Note that the orientation of print medium 10 as depicted in FIG. 4 is upside-down relative to the depictions of FIGS. 2 and 3, such that first layer 12 is shown below second layer 20, whereas in the depictions of FIGS. 2 and 3, second layer 20 is depicted as being above first layer 12, e.g., an orientation as might occur when print medium 10 is being printed in a typical ink jet imaging apparatus.

In stack 24, each print medium 10 is covered by another print medium 10 such that first layer 12 of one instance of print medium 10 is in protective contact with second layer 20 of an adjacent instance of print medium 10. Accordingly, first side 14 of first layer 12 of print medium 10 is configured to be separable from second layer 20 such that one instance of print medium 10, e.g., the top one, may be peeled off the next print medium 10 when needed for printing, without separating second layer 20 from second side 16 of first layer 12 of the print medium 10 being removed from the stack for printing. In the example of FIG. 4, in order to protect the bottom instance of print medium 10 from contamination of its second layer 20, a separable sheet 25, such as part of the packaging material used to package stack 24 of print media 10, is employed.

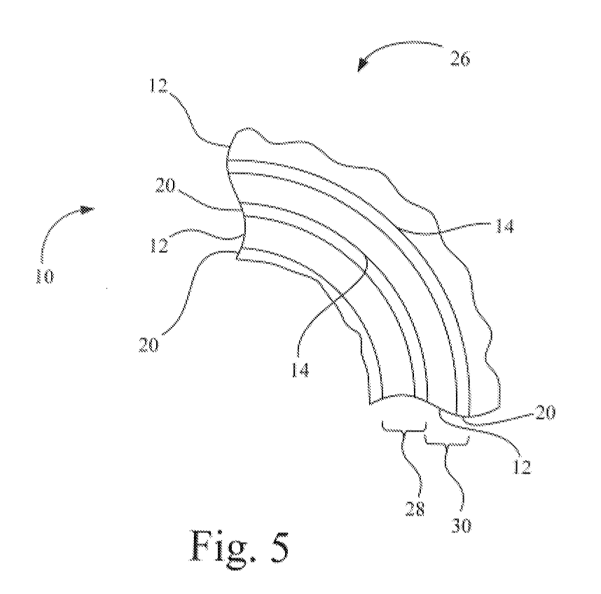

Referring now to FIG. 5, another embodiment of print medium 10 that does not include third layer 22 is a supply of print media 10 that is configured and packaged in the form of a roll 26 of print medium 10, the first side 14 of a first portion 28 of adhesive print medium 10 being in protective contact with second layer 20 of a second portion 30 of print medium 10. As with the embodiment of FIG. 4, in the embodiment of FIG. 5, first side 14 of first layer 12 of print medium 10 is configured to be separable from second layer 20 such that roll 26 of print medium 10 may be unrolled to expose print medium 10 for printing, without separating second layer 20 from second side 16 of first layer 12.

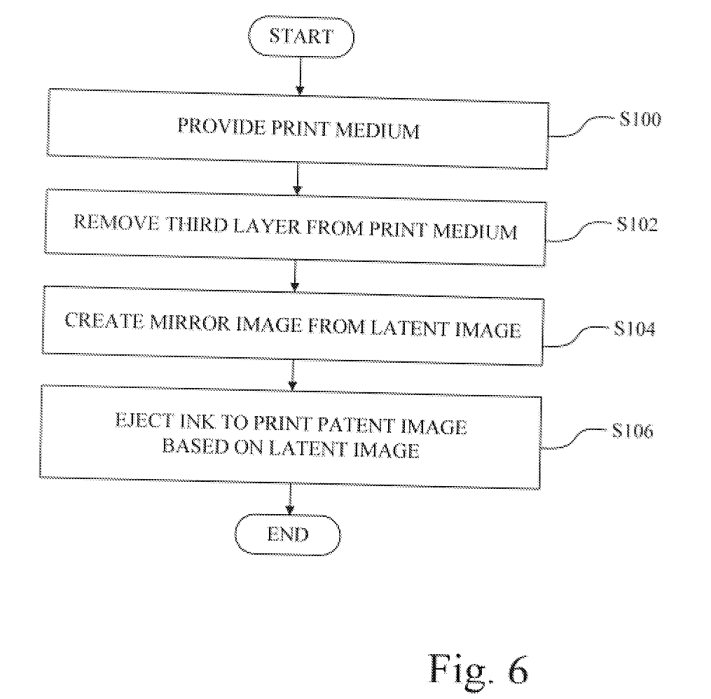

Referring now to FIG. 6, an embodiment of a method of printing an image on an adhesive print medium is described with respect to steps S100-S106. The image may be any image sought to be printed by a user of an ink jet imaging apparatus, and prior to printing, is a latent image residing in a computer-readable memory, such as a memory of the ink jet imaging apparatus, of a computer connected to the ink jet imaging apparatus, or of some peripheral device communicatively interconnected with the imaging apparatus.

At step S100, an adhesive print medium 10 for use with an ink jet imaging apparatus is provided.

Referring again to FIG. 3, Print medium 10 includes first layer 12 having first side 14 and second side 16, and compound 18 applied to second side 16 of first layer 12. As set forth in previous embodiments, compound is formulated as both an adhesive and an ink receiving substrate to receive and retain the ink ejected from the ink jet imaging apparatus, and forms, second layer 20. In addition, as set forth above with respect to previous embodiments, in the present embodiment, print medium 10 includes third layer 22 positioned adjacent second layer 20, which is separable from second layer 20.

Referring again to FIG. 6, at step S102, third layer 22 is separated from second layer 20 prior to printing, for example, by peeling third layer 22 off second layer 20.

At step S104, a mirror image of the latent image is created, for example, by the ink jet imaging apparatus or associated driver software.

At step S106, ink is ejected from the imaging apparatus onto second layer 20 to print a patent image based on the latent image as mirrored in step S104.

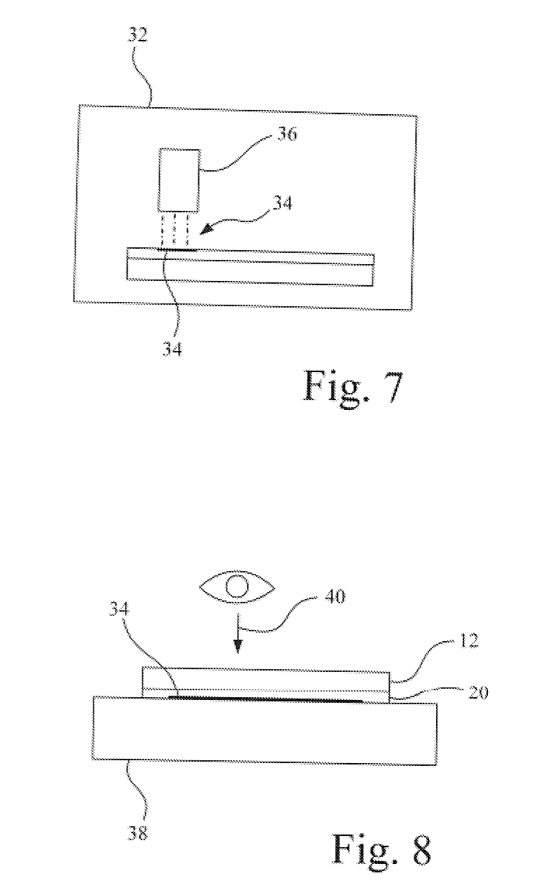

Referring now to FIG. 7, print medium 10 is depicted as being printed upon by a typical ink jet imaging apparatus 32 ejecting ink 34 onto second layer 20 via a conventional printhead 36.

After having been printed, the user may apply print medium 10 to the desired article.

Referring now to FIG. 8, the user applies print medium 10 to an article 38, with second layer 20 coming into contact with and adhering to article 38. As seen in FIG. 8, the image formed by the ink 34 ejected onto second layer 20 is immediately adjacent the article, and is viewed in direction 40 from the opposite side of first layer 12, i.e., from first side 14, an arrangement which protects second layer 20 and the ink printed thereon from damage or contamination, since that surface is positioned between first layer 12 and article 38. Because the latent image was mirrored prior to printing, when viewed in direction 40, the image appears in the proper orientation.

As set forth above, with the present invention, a user is able make a customized label or post and apply it to any desired article for home or business, e.g., office, use. In addition, for embodiments having first layer 12 that is flexible, print medium 10 may be printed upon using any commercially available ink jet imaging apparatus, e.g., a home or office printer. Further, because print medium 10 may only employ two or three layers, depending upon whether third layer 22 is desired for a particular application, cost may be kept at a minimum. Still further, first layer 12 functions as a protective layer for the printed image to provide protection against damage caused by water, scratches, smearing and smudging, staining, and oxidation, but without the need for a separate protective layer to be applied subsequent to printing.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An adhesive print medium for use with an ink jet imaging apparatus, comprising:
a first layer having a first side and a second side;
a compound applied to said second side of said first layer, said compound being formulated as both an adhesive and an ink receiving substrate to receive and retain ink ejected from said ink jet imaging apparatus, said compound forming a second layer,
wherein said ink ejected from said ink jet imaging apparatus is viewed from said first side of said first layer.

2. The adhesive print medium of claim 1, further comprising a third layer positioned adjacent said second layer opposite and first layer, said third layer being in protective contact with said second layer.

3. The adhesive print medium of claim 2, wherein said third layer is separable from said second layer.

4. The adhesive print medium of claim 1, wherein said second layer is inseparable from said second side of said first layer.

5. The adhesive print medium of claim 1, further comprising said first side of said first layer being configured to be separable from said second layer.

6. The adhesive print medium of claim 5, wherein:
said adhesive print medium is configured in the form of a roll, said first side of a first portion of said adhesive print medium being in protective contact with said second layer on a second portion of said adhesive print medium.

7. The adhesive print medium of claim 1, said compound including ink-receiving materials.

8. The adhesive print medium of claim 7, wherein said ink-receiving materials are porous.

9. The adhesive print medium of claim 7, wherein said ink-receiving materials are configured to absorb said ink ejected from said ink jet imaging apparatus.

10. The adhesive print medium of claim 1, wherein said first layer is a transparent sheet.

11. The adhesive print medium of claim 1, wherein said first layer is a translucent sheet.

12. The adhesive print medium of claim 1, wherein said first layer is an opaque sheet.

13. The adhesive print medium of claim 1, wherein said second layer is transparent.

14. The adhesive print medium of claim, wherein said second layer is translucent.

15. The adhesive print medium of claim 1, wherein said second layer is opaque.

16. A method of printing an image on an adhesive print medium, comprising:
providing said adhesive print medium for use with and ink jet imaging apparatus, said adhesive print medium including:
a first layer having a first side and a second side;
a compound applied to said second side of said first layer, said compound being formulated as both an adhesive and an ink receiving substrate to receive and retain ink ejected from said ink jet imaging apparatus, said compound forming a second layer; and
ejecting said ink from said imaging apparatus onto said second layer to print a patent image based on a latent image,
wherein said patent image is viewed from said first side of said first layer.

17. The method of claim 16, further comprising creating a mirror image of said latent image prior to said ejecting said ink from said imaging apparatus.

18. The method of claim 16, said adhesive print medium further including a third layer positioned adjacent said second layer opposite said first layer, wherein said third layer is separable from said second layer, said method further comprising separating said third layer from said second layer prior to said printing said latent image.

19. The method of claim 16, wherein said first side of said first layer is configured to be separable from said second layer.

20. The method of claim 19, wherein:
said adhesive print medium is configured in the form of a roll, said first side sofa first portion of said adhesive print medium being in protective contact with said second layer on a second portion of said adhesive print medium.
